(19) United States
(12) Patent Application Publication
(10) Pub. No.: US 2011/0083538 A1
(43) Pub. Date: Apr. 14, 2011

(54) BAND SAW

(76) Inventors: Hans DIETZ, Ammerbuch (DE); Erwin Resch, Oberaudorf (DE)

(21) Appl. No.: 12/900,751

(22) Filed: Oct. 8, 2010

Related U.S. Application Data
(63) Continuation of application No. PCT/EP2009/001552, filed on Mar. 5, 2009.

(30) Foreign Application Priority Data
Apr. 8, 2008 (DE) 10 2008 018 443.8

(51) Int. Cl. B23D 55/08; B23D 53/00

(52) U.S. Cl. 83/169; 83/820

(57) ABSTRACT

A band saw has a band saw blade and a guide for the band saw blade. The guide comprises at least two magnets enclosing the band saw blade within a gap between them and exerts on the band saw blade a force influencing a position thereof in space. A blow out device is provided which is connected to the gap.

### CROSS REFERENCES TO RELATED APPLICATIONS

This application is a continuation of international patent application PCT/EP2009/001552 filed on Mar. 5, 2009 designating the U.S., which international patent application has been published in German language and claims priority from German patent application DE 10 2008 018 443.8 filed Apr. 8, 2008. The entire contents of these priority applications are incorporated herein by reference.

### FIELD OF THE INVENTION

The invention is related to the field of band saws.

More specifically, the invention is related to a band saw having a band saw blade with a guide for the band saw blade, wherein the guide comprises at least two magnets enclosing the band saw blade within a gap between them and exerting on the band saw blade a force influencing a position thereof in space.

### BACKGROUND OF THE INVENTION

A band saw of the type specified above is described in U.S. patent application Ser. No. 12/274,751 published as 2009/0126549 A1 and incorporated herein by way of reference.

In the known band saw the band saw blade is guided in a vertical direction through a gap between two magnetic guides positioned close next to each other.

As considerable amounts of chips, typically wood chips, are generated during sawing, these chips enter into the gap between the magnetic guides being located beneath the sawing table. Considering that for an optimal guiding of the band saw blade this gap has to be dimensioned as a narrow air gap in order to make the distance between the magnets of the magnetic guide as small as possible, it may happen that the generated chips clog the gap and, thereby, effect a braking or even a forced standstill of the band saw blade. Likewise, the precision of the guide, in particular the linearity of the cut may thereby be worsened.

The clogging of the gap is also caused by a vacuum generated within the gap by the band saw blade running through the gap and sucking the chips thereinto.

### SUMMARY OF THE INVENTION

It is, therefore, an object underlying the invention, to improve a band saw of the type specified at the outset such that the aforementioned disadvantages are avoided. In particular it shall be ensured that the band saw runs without malfunction and that the magnetic guide located beneath the sawing table is not clogged by chips.

With a band saw of the type specified at the outset this object is achieved in that there is provided a blow out device connected to the gap.

The object underlying the invention is, thus, entirely solved.

By providing a blow out device the chips are namely removed in good time before entering into the trajectory of the band saw blade, such that they are not drawn into the gap between the magnetic guides where they could cause malfunctions.

In a preferred improvement of the band saw according to the invention the band saw blade runs through an item to be sawn in a predetermined sawing direction, and that the blow out device is located at a guide positioned immediately behind the item to be sawn as viewed in the sawing direction.

This measure has the advantage that the inventive effect starts exactly at a position where a removal of the chips is particularly required.

In a refinement of the aforementioned embodiment the blow out device is located on the side of the guide facing the item to be sawn.

This measure, too contributes to remove the chips from the band saw blade trajectory as soon as possible.

In another variant of the mentioned embodiment the band saw blade is provided with teeth on a longitudinal side, and that the blow out device directs an air stream on the longitudinal side of the band saw blade opposite the teeth.

This measure has the advantage that the chips are removed away from the band saw blade by directing the air stream in a direction perpendicular to the sawing direction and from the back to the front onto the band saw blade.

In a particularly preferred and practical embodiment of the invention the guides enclose the band saw blade between them with essentially plane lateral surfaces and with a predetermined distance, and that the distance is enlarged on the side facing the item to be sawn, such that a first channel each is created on the side between the guides and the band saw blade.

This measure has the advantage that a controlled air guide happens by the lateral sides of the band saw blade within a predetermined channel which guides the air stream generated by the blow out device laterally by the band saw blade towards the teeth thereof and then away from the teeth.

In a refinement of the aforementioned embodiment the blow out device comprises two second channels for ejecting the air stream, and that the first channels are flush with the second channels.

This measure has the advantage that the air stream from the blow out device is conveyed by the sides of the band saw blade with minimum losses.

Finally, another embodiment of the invention is preferred in which a wiper each is provided between the guides and the band saw blade.

This measure has the advantage that in particular in combination with the above mentioned first channels a fully closed channel is created enabling a particularly effective guiding of the air.

Further advantages will become apparent from the description and the enclosed drawing.

It goes without saying that the features mentioned before and those that will be explained hereinafter may not only be used in the particularly given combination but also in other combinations or alone without leaving the scope of the present invention.

### BRIEF DESCRIPTION OF THE DRAWINGS

Embodiments of the invention are depicted in the drawings and will be explained in further detail in the subsequent description.

FIG. 1 shows a front elevational view of a band saw according to the prior art;

FIG. 2 on an enlarged scale shows a top plan view of a magnetic guide of the band saw of FIG. 1 in connection with a blow out device according to the present invention, in a view along the line II-II of FIG. 3; and

FIG. 3 shows a rear view of the arrangement of FIG. 2, along the line of FIG. 2.

### DETAILED DESCRIPTION OF THE PREFERRED EMBODIMENTS

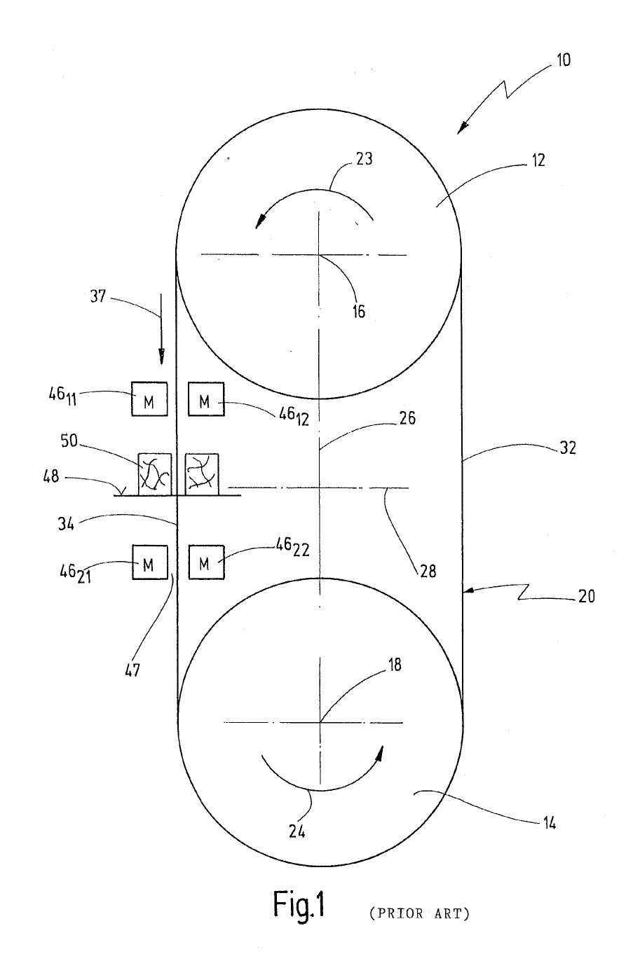

In FIG. 1 reference numeral 10 as a whole designates a band saw as typically used in sawmills for dissecting logs, for dissecting and edging boards, and the like. Band saw 10 may be stationarily installed within a sawmill installation or may be configured as a mobile unit.

Band saw 10 comprises an upper wheel 12 and a lower wheel 14 which rotate about a horizontal upper axis 16 and a horizontal lower axis 18. A band saw blade 20 is wound under tension around wheels 12 and 14. Band saw blade 20 is provided with teeth 21 and chip space 22 on its front side in FIG. 1. However, also double-teethed saw blades may be used which cut in a forward and also in a backward direction.

Arrows 23 and 24 indicate the direction of rotation of wheels 12 and 14. The arrangement of wheels 12 and 14 is at least roughly symmetrical with respect to a vertical axis 26 intersecting axes 16 and 18 as well as with respect to a horizontal axis 28 extending in the middle between axes 16 and 18.

In FIG. 1 the right saw blade section is designated by 32 and the left saw blade section by 34. From the directions of rotation 23 and 24 of wheels 12 and 14 follows a downward running direction of saw blade 20 in its left saw blade section 34, as indicated by an arrow 37. Right saw blade section 32 and left saw blade section 34 extend tangentially with respect to wheels 12 and 14. Left saw blade section 34, however, may also keep a distance to a tangent line on the left hand side of wheels 12 and 14, as known per se.

Left saw blade section 34 runs through an upper guide and through a lower guide. The guides are configured as pairs of magnetic guides 46₁₁, 46₁₂, and 46₂₁, 46₂₂, respectively. Magnetic guides pairs 46₁₁, 46₁₂, and 46₂₁, 46₂₂ are positioned one next to another and enclose between them a gap 47 through which band saw blade 20 runs.

The pairs of magnetic guides 46₁₁, 46₁₂, and 46₂₁, 46₂₂ are positioned one above another. Between them there is provided a sawing table 48 on which an item to be sawn 50, for example a wood board, is pushed through band saw 10, namely in the illustration of FIG. 1 vertically to the drawing plane from the front to the back.

Magnetic guides 46₁₁, 46₁₂, and 46₂₁, 46₂₂ laterally guide saw blade section 34 during sawing and allow the saw blade to rotate about a vertical axis. Details in this regard are described in U.S. patent application 2009/0126549 A1 to which reference is made.

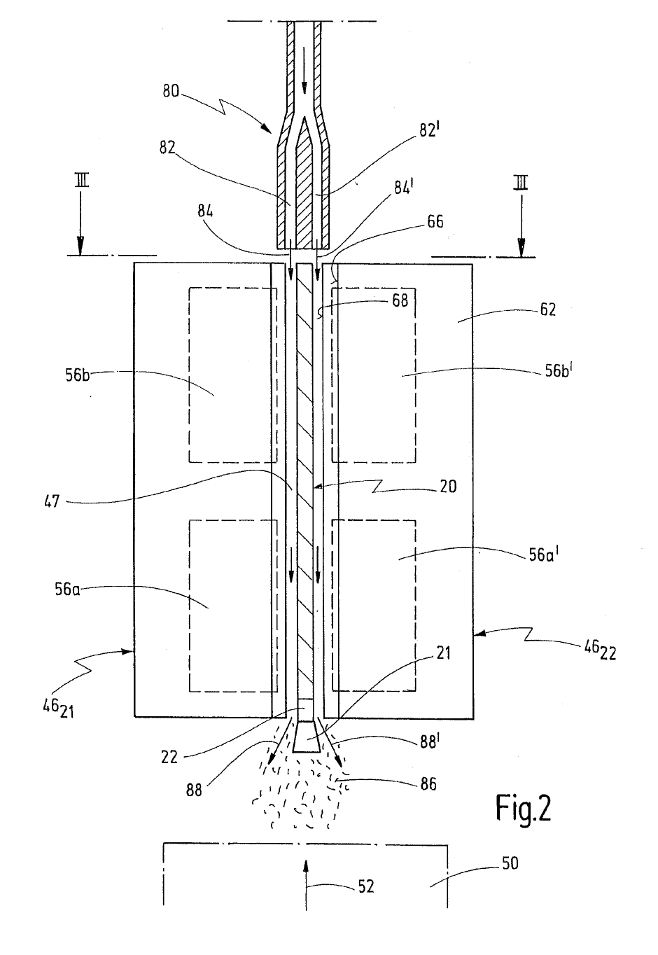

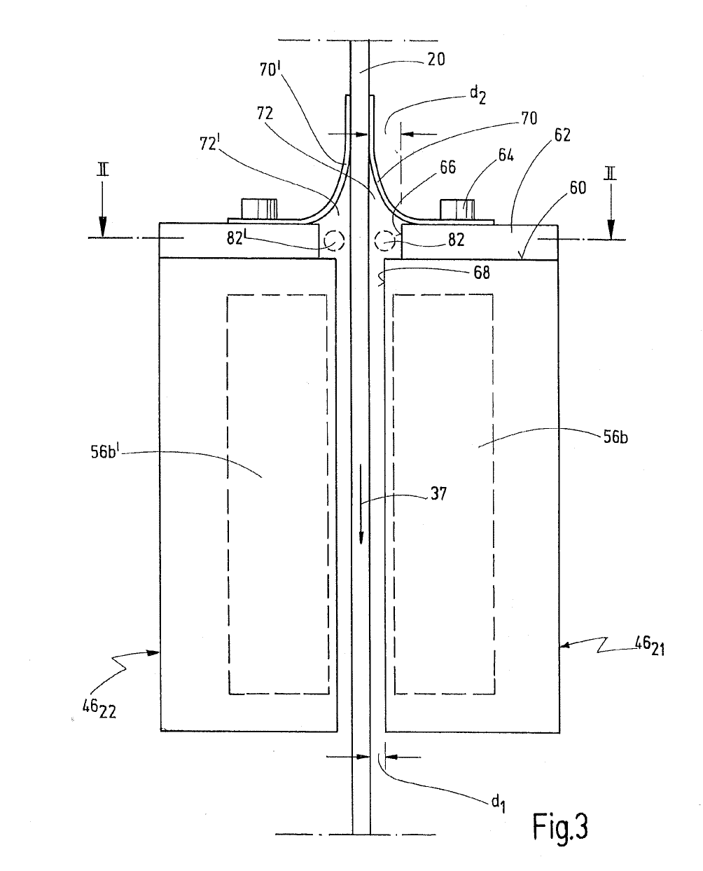

FIG. 2 shows a top plan view and FIG. 3 a rear view of the lower pair of magnetic guides 46₂₁ and 46₂₂ from FIG. 1. At the bottom of FIG. 2 one can see item to be sawn 50 being pushed in a horizontal feed direction 52 towards teeth 21 of band saw blade 20.

In FIG. 2 one can further see that magnetic guides 46₂₁ and 46₂₂ are each provided with front magnets 56a and 56a′ as well as with rear magnets 56b and 56b′, as each seen in feed direction 52. By selectively powering magnets 56a, 56a′, 56b and 56b′ band saw blade 20 may be moved in FIG. 2 from right to left and may be rotated about a vertical axis as known per se. The magnetic guides typically have an effective surface of between 20×B cm and 5×B cm with B being the width of saw blade 20 between the saw blade back and the bottom of teeth 21. For double-teethed saw blades B is the distance between the two front and back teeth bottoms.

FIG. 3 illustrates that on an upper surface 60 of magnetic guides 46₂₁ and 46₂₂ facing the sawing table above them there is each bolted a plate 62 by means of bolts 64. Plates 62, as seen in feed direction 52 are as long as magnetic guides 46₂₁ and 46₂₂, however, in the area of surface 60 they are laterally more distant. Whereas namely the distance between magnetic guides 46₂₁ and 46₂₂ and band saw blade 20 is each only d₁, in practice typically 1 mm, inner lateral surfaces 66 of plates 62 have a distance d₂ of typically between 2 and 7 mm from band saw blade 20.

Preferably, wipers 70 are attached to plates 62 by means of bolts 64. Wipers 70 lie in feed direction against both sides of band saw blade 20 until short off teeth 21 and, thereby, tightly enclose band saw blade 20 between them. Wipers 70, 70′ preferably consist of an elastic plastic material or of other low wear materials, for example thin spring steel. Wipers 70 may also consist of a plate similar to plate 62 which, in turn, is likewise positioned at a distance of 1 mm from band saw blade 20 in its residual position. It may also be pressed permanently against both sides of band saw blade 20 with a small force of some N.

Through the enlarged distance of plates 62 between their lateral sides 66 and in particular through the optional provision of wipers 70, 70′ first channels 72, 72′ are created on both sides of band saw blade 20.

In feed direction 52 behind magnetic guides 46₂₁ and 46₂₂, there is provided a blow out device 80 as can clearly be seen in FIG. 2. Blow out device 80 is provided with two second channels 82, 82′ being flush with first channels 72, 72′, as indicated in FIG. 3. Blow out device 80 is connected to a compressed air source (not shown).

Blow out device 80 thereby generates two air streams 84, 84′ which enter into first channels 72, 72′ from the rear side of band saw blade 20 and laterally flow along band saw blade 20. When during sawing of item to be sawed 50 chips 86 are generated in the area of teeth 21 of band saw blade 20 and are taken along downwardly into the area of magnetic guides 46₂₁ and 46₂₂, then these chips 86 are catched by air streams 84, 84′ and are conveyed away outside as indicated by arrows 88, 88′ in FIG. 2. Air streams 84, 84′ in particular generate an elevated pressure within first channels 72, 72′ which compensates or over-compensates the vacuum generated by band saw blade 20 when running through.

If double-teethed band saw blades with two opposite feed directions 52 are to be used, one preferably provides for two symmetrically positioned blow out assemblies 80 which are activated alternately depending on the prevailing feed direction.

If optional wipers 70, 70′ are provided in the described manner as elastic elements or plates, they cover first channels 72, 72′ from above and, thereby already substantially prevent the entering of chips 86 into gap 47 between magnetic guides 46₂₁ and 46₂₂ and the band saw blade 20. The chips 86 which in that situation still enter into first channels 72, 72′ are therein taken along by air streams 84, 84′ and are removed forwardly into the exterior space. Gap 47, thereby remains practically free of chips 86.

1. A band saw having a band saw blade with a guide for said band saw blade, wherein said guide comprises at least two magnets enclosing said band saw blade within a gap between them and exerting on said band saw blade a force influencing a position thereof in space, wherein there is provided a blow out device connected to said gap.

2. The band saw of claim 1, wherein said band saw blade runs through an item to be sawn in a predetermined sawing direction, said blow out device being located at said guide positioned immediately behind said item to be sawn as viewed in said sawing direction.

3. The band saw of claim 2, wherein said blow out device is located on a side of said guide facing said item to be sawn.

4. The band saw of claim 2, wherein said band saw blade is provided with teeth on a longitudinal side, and that said blow out device directs an air stream on said longitudinal side of said band saw blade opposite said teeth.

5. The band saw of claim 3, wherein said guides enclose said band saw blade between them with essentially plane lateral surfaces and with a predetermined distance, said distance being enlarged on a side facing said item to be sawn, such that a first channel each is created on said side between said guides and said band saw blade.

6. The band saw of claim 5, wherein said blow out device comprises two second channels for ejecting an air stream, said first channels being flush with said second channels.

7. The band saw of claim 1, wherein a wiper each is provided between said guides and said band saw blade.

8. A band saw comprising a band saw blade running through an item to be sawn in a predetermined feed direction, said band saw blade having a first longitudinal narrow side provided with teeth, a guide for said band saw blade having at least two magnets enclosing within a gap between them lateral broad sides of said band saw blade and exerting a force on said band saw blade for influencing a position in space thereof, means for generating an air stream guided along said teeth for taking along chips, said means being configured as a blow out device connected to said gap and directing said air stream on a second longitudinal narrow side of said band saw blade opposite said first narrow longitudinal side.

9. The band saw of claim 8, wherein said blow out device is located at said guide positioned immediately behind said item to be sawn as viewed in said sawing direction.

10. The band saw of claim 8, wherein said blow out device is located on a side of said guide facing said item to be sawn.

11. The band saw of claim 8, wherein said guides enclose said band saw blade between them with essentially plane lateral surfaces and with a predetermined distance, said distance being enlarged on a side facing said item to be sawn, such that a first channel each is created on said side between said guides and said band saw blade.

12. The band saw of claim 11, wherein said blow out device comprises two second channels for ejecting an air stream, said first channels being flush with said second channels.

13. The band saw of claim 8, wherein a wiper each is provided between said guides and said band saw blade.
